(19) United States
(12) Patent Application Publication
(10) Pub. No.: US 2008/0085682 A1
(43) Pub. Date: Apr. 10, 2008

(54) Mobile device sharing pictures, streaming media and calls locally with other devices

(76) Inventor: Bindu Rama Rao, Laguna Niguel, CA (US)

Correspondence Address: BINDU RAMA RAO, 21 HENLEY DRIVE, LAGUNA NIGUEL, CA, 92677, US

(21) Appl. No.: 11/810,597

(22) Filed: Jun. 5, 2007

Related U.S. Application Data
(60) Provisional application No. 60/849,715, filed on Oct. 4, 2006.

(51) Int. Cl. H04B 1/40

(52) U.S. Cl. 455/74

(57) ABSTRACT

Using a local sharing client, a first mobile device shares incoming calls, streaming media, pictures, etc. locally (without employing a cellular wireless network) with a second device. The second device may also have a similar client and be able to share locally with the first mobile device.

### CROSS REFERENCES TO RELATED APPLICATIONS

The present application makes reference to, claims priority to, and claims benefit of U.S. Provisional Application Ser. No. 60/849,715 entitled MOBILE DEVICE SHARING PICTURES, STREAMING MEDIA AND CALLS LOCALLY WITH OTHER DEVICES (Attorney Docket No. BRR2006US02) filed on Jul. 7, 2006, the complete subject matter of which is hereby incorporated herein by reference, in its entirety.

### BACKGROUND

1. Technical Field

The present invention relates generally to the interactions between a mobile device and other devices, and more specifically to the localized sharing of streaming media and other content with other mobile devices.

2. Related Art

Electronic devices, such as mobile phones and personal digital assistants (PDA's), often contain small screens with very limited viewing area. They are constrained in terms of how much information can be displayed, and in terms of user interaction capabilities. Quite often when a user gets a phone call, he cannot let his friends in proximity listen to the voice conversation conducted over the phone, especially if the premises is noisy. Some phones have a speakerphone that can be used to amplify the phone conversation such that it can be heard by a few individuals who are close to the phone. However, this requires all the individuals who want to hear the conversation to be very close to the phone. Thus sharing incoming voice calls with others who want to listen to it by using a speakerphone, especially in noisy premises and in locations where people cannot huddle close to the phone, is quite impossible if not impractical. Conference call facilities are available on a cell phone. However, it is more expensive in terms of call time and it also requires the use of additional network resources. Thus, there is no easy way to share an incoming call with others who want to listen to it, especially in crowded or noise places and in places where people are not too close to each other although they are in the vicinity.

Sometimes, when a user gets a call on a mobile phone, the user may wish to have it transferred or forwarded to another mobile phone that is nearby in the premises. Call forwarding and call transfer solutions exist today, but they require the use of additional network resources and additional call setup features or call control mechanisms. For example, for call forwarding to work, the wireless or PSTN network is used to dial the number of the new call destination (often automatically) and the use of call forwarding logic/services in the network (wireless or PSTN). In addition, a subscriber has to have a subscription for such services and pay additional monthly charges too. In addition, the other device to which a call forwarding and a transfer might be targeted has to also have a network service—devices without network service (often from the same network service provider) cannot be the target of call forwarding if they do not have a subscription associated.

Some mobile devices are capable of receiving streaming media. A user may wish to not only listen to it but also share it with others in close proximity. However, there is no easy solution for sharing them on mobile phones. Typically, a mobile phone cannot be holed up to an LCD projector for sharing streaming media being received. In addition, LCD projectors and screens are expensive way to share streaming media being received by a user on a mobile phone.

Today, there exist a few techniques for distribution of digital media onto more than one PC or computer. These techniques require broadcasting or multicasting mechanisms and equipment and use additional network bandwidth and resources. There is no easy method to share digital media between mobile devices that are in close proximity with out using wireless network resources such as those provided by 3G networks.

Quite often a user may play an audio or video content on his mobile device. The user has no easy way to share the viewing or listening experience with others in the premises without using the wireless network or some or network infrastructure such as LAN, with extra costs associated with such sharing.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

The numerous objects and advantages of the present invention may be better understood by those skilled in the art by reference to the accompanying figures in which:

FIG. 1 is a perspective diagram of a mobile device that is capable of sharing streaming media and incoming calls locally with other devices, such as the mobile device;

FIG. 2 is a flow chart showing typical usage of a source mobile device, in accordance with the present invention, for sharing media/content received by the source mobile device with another recipient mobile device;

FIG. 3 is a flow chart of an exemplary operation of the mobile device, in accordance with the present invention, wherein incoming voice calls are shared with other mobile devices in proximity, without employing traditional call forwarding features or setting up a conference call; and

FIG. 4 is a flowchart of a sharing mobile device wherein a media sharing manager in the sharing mobile device manages discovery of other devices in its proximity and the setting up of sharing activities with those discovered devices;

FIG. 5 is a flowchart of a media sharing mobile device where sharing is conducted by means of low-power local broadcasts wherein such broadcasts can be terminated either by a user of the sharing device or at the end of a media stream that is broadcast;

FIG. 6 is a perspective block diagram of a local media sharing network wherein more than one listening client devices can share media streams being locally shared by a source mobile device with Bluetooth connectivity;

FIG. 7 is a perspective block diagram of a local sharing environment wherein a wireless network provides various kinds of online broadcast data as well as voice calls and wherein a source mobile device receives them and shares them locally with one or more listening client devices;

FIG. 8 is a perspective block diagram of an infrastructure where a first mobile device associated and communicatively coupled to a wireless network is capable of conducting a local call transfer, without involving a wireless network, to a second mobile device; and

FIG. 9 is a perspective block diagram of a first mobile device that can share its pictures taken on an onboard/built-in camera with other devices using a locally sharing means.

### DETAILED DESCRIPTION OF THE DRAWINGS

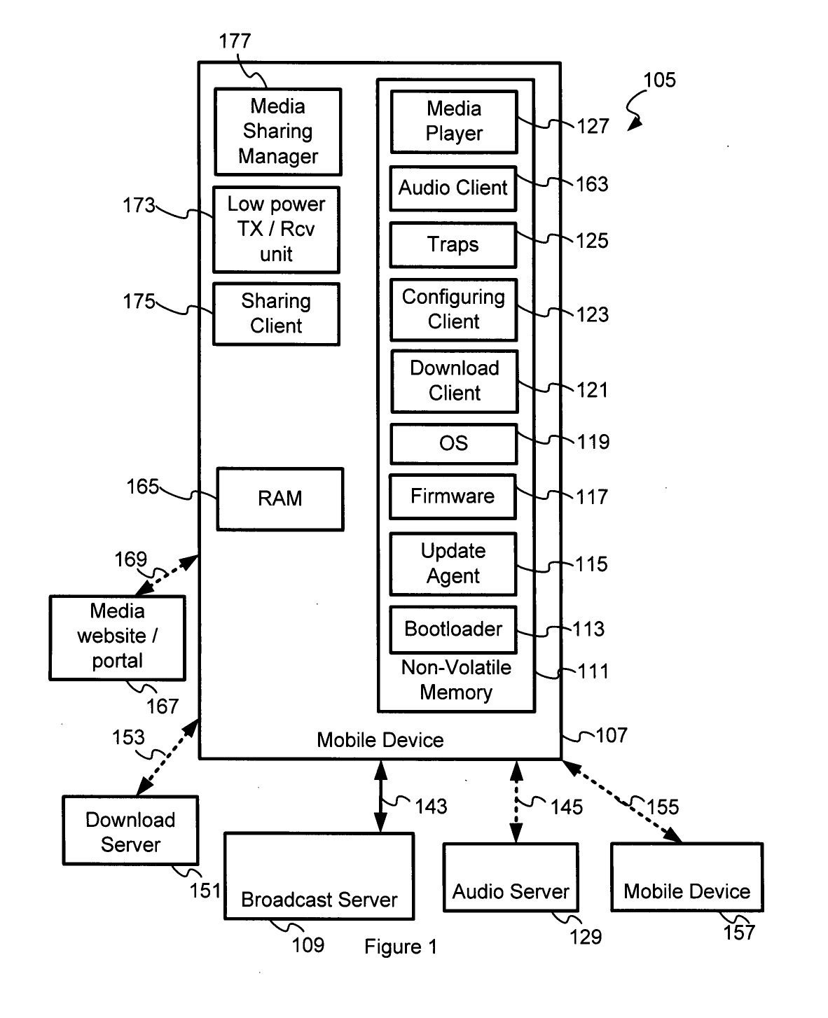

FIG. 1 is a perspective diagram of a mobile device 107 that is capable of sharing streaming media and incoming calls locally with other devices, such as the mobile device 157. The mobile device 107 is part of a network 105, such as a wireless network, with access to voice and data services. The mobile device 107 is communicatively coupled with the media website/portal 169 that provides multimedia content that can be viewed on the mobile device 107 and a download server 153 that can be used to download audio and video content such as mp3, wma, MPEG2, MPEG3, etc. The mobile device 107 is also communicatively coupled with a broadcast server 109, such as a DVBH server or a TV broadcast station, and to an audio server 129, such as an Apple iTunes server, a real-audio based streaming server, etc.

The mobile device 107 employs a sharing client 175 that makes it possible to share data with other mobile devices, such as a mobile device 157. The mobile device 107 employs a local communication means 155, which is often a low power communication means such as Bluetooth, to communicate with the mobile device 157. A media sharing manager 177 in the mobile device 107 manages the establishment of the communication means 155 with the mobile device 157 and the subsequent media sharing.

The sharing client 175 facilitates sharing of incoming voice calls handled by the mobile device 157, such sharing occurring without the use of the wireless network on which the mobile device 107 typically operates. Thus, the communication means 155 is some protocol other than the RF protocols used for GSM or CDMA based wireless networking. It is based on protocols used for low power communication of devices that are in proximity, such as devices that are within 1 feet to 30 feet of each other, such as Bluetooth.

The sharing client 175 makes it possible to share the content currently being rendered, played or displayed by a media player 127 in the mobile device 107 with another mobile device 157 in its vicinity. The sharing client 175 also makes it possible to share the audio content currently being rendered, played or displayed by an audio client/player 163 in the mobile device 107. For example, the audio client 163 may be an Apple iTunes client, another MP3 player client, etc.

The sharing client 175 makes it possible to share specific stored or streaming content (audio, or video) that is currently being displayed, played or rendered by a typical client in the mobile device 107 with another mobile device in its proximity, such as the mobile device 157.

In one embodiment, the recipient mobile device 157 also comprises a sharing client 175 that is capable of negotiating sharing of media streams and other content with the sharing client 175 of the source mobile device 107. For example, it is capable of negotiating a channel for communication, buffer sizes, etc. In a related embodiment, the recipient mobile device 157 also comprises a sharing client 175 that is capable of temporarily suspending sharing when an incoming phone call is received. It is also able to terminate sharing and letting the sharing client 175 of the source mobile device 107 know that it is pausing or terminating sharing. In general, the recipient mobile device 157 is capable of starting, stopping, pausing and otherwise controlling the sharing of media streams and content with the sharing client 175 of the source mobile device 107.

In general, a mobile device is a cellular phone that works on a GSM, CDMA, 3G or other cellular infrastructure. It can also be a converged device that works on one or more of 2G, 2.5G or 3G networks while also capable of working on (sometimes even simultaneously) WLAN or WiMAX networks. It can also be a PDA that works on LANs. Other forms of mobile devices are also contemplated, such as watches with network capabilities, small hand held devices with scanners attached, etc.

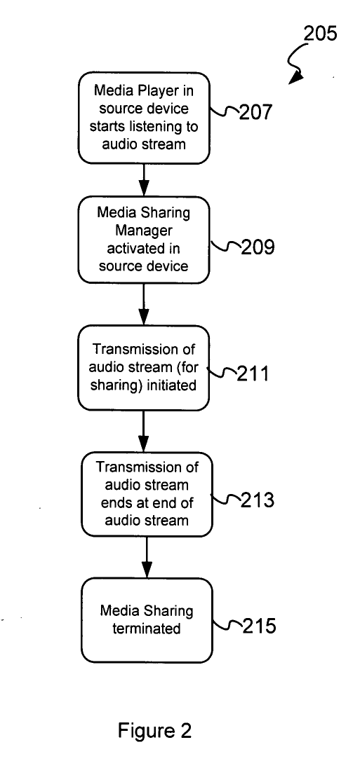

FIG. 2 is a flow chart 205 showing typical usage of a source mobile device, in accordance with the present invention, for sharing media/content received by the source mobile device with another recipient mobile device. At a start block 207, the source mobile device, that comprises a media player, either starts receiving an audio stream from an external source (such as a media server) or from a storage in the source mobile device. Then the media player in the source mobile device starts listening to the audio stream (or multi-media stream in general). Then, at a next block 209, the media sharing manager is activated in the source mobile device. Then at a next block 211, transmission of the audio stream for the purposes of sharing locally with one or more recipient devices is initiated. The sharing may be preconfigured such that the list of one or more recipient devices is known to the source mobile device. In one embodiment, the sharing may also be accompanied by a discovery process where, based on user input that is solicited, or based on pre-configured preferences, the media sharing manager discovers the recipient devices and starts negotiating the transmission of the audio stream (multi-media stream in general).

At a next block 211, transmission of the audio stream for sharing is initiated in the source mobile device. Then, at a next block 213, the transmission of the audio stream ends at the end of the audio stream, when the end is encountered. In a related embodiment, the user may also initiate the termination of the transmission too. Finally, at the next block 215, the media sharing is terminated.

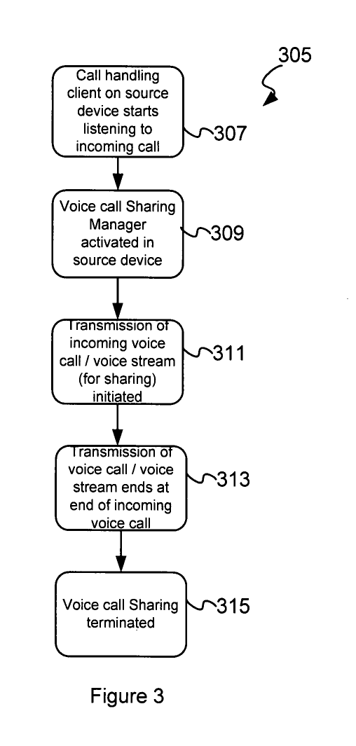

FIG. 3 is a flow chart 305 of an exemplary operation of the mobile device, in accordance with the present invention, wherein incoming voice calls are shared with other mobile devices in proximity, without employing traditional call forwarding features or setting up a conference call. At a start block 307, a call handling client in the source mobile device starts listening to incoming calls. At a next block 309, when an incoming voice call is detected, based on the configuration information, the voice call sharing manager is activated. In one embodiment, during the voice call sharing manager is activated as needed in the middle (during) of a current voice call, and subsequently sharing can be terminated in the middle of a current call, without the call itself being terminated.

At a next block 311, the transmission of the incoming voice call or voice stream is initiated for sharing it with one or more other recipient mobile devices in proximity. Later, at a next block 313, the transmission of voice call ot voice stream ends at the end of the incoming voice call. Finally, at a next block 315, the voice call sharing is terminated.

It should be noted that the sharing of a current voice call can be terminated by the user of the source mobile device. In addition, the recipient device also facilitates termination of sharing of the voice call, such as when it determines that it is about to receive its own incoming voice call.

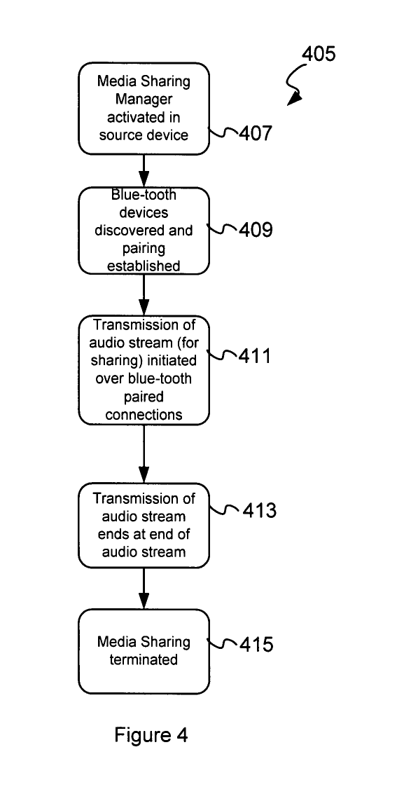

FIG. 4 is a flowchart of a sharing mobile device wherein a media sharing manager in the sharing mobile device manages discovery of other devices in its proximity and the setting up of sharing activities with those discovered devices. At a start block 407, the media sharing manager is activated in the source device. Then, at a next block 409, the media sharing manager facilitates the discovery of other devices in proximity. In one embodiment, where the connectivity with other devices for sharing is over Bluetooth protocols, it discovers other Bluetooth devices and establishes pairing with them.

Then, at a next block 411, the transmission of audio stream for staring is initiated over the available/established connectivity, such as the paired Bluetooth connections. Then, at a next block 413, at the end of the media stream, such as an audio stream, transmission ends. Finally at a next block 415, the media sharing is terminated 415. In one embodiment, all established local connections are also terminated. In another embodiment, all established local connections are continued in anticipation of a subsequent media sharing event.

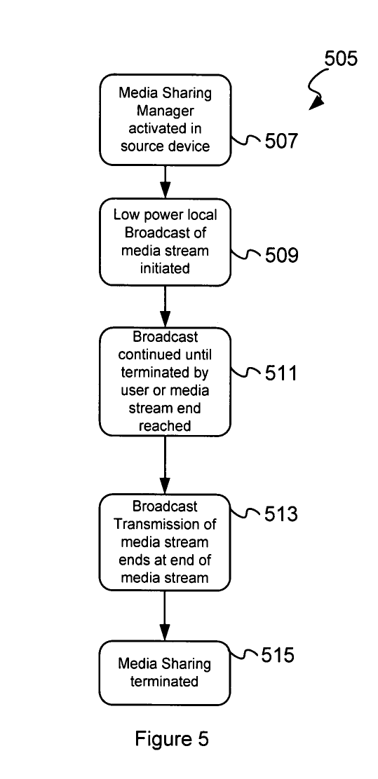

FIG. 5 is a flowchart 505 of a media sharing mobile device where sharing is conducted by means of low-power local broadcasts wherein such broadcasts can be terminated either by a user of the sharing device or at the end of a media stream that is broadcast. At a start block 507, the media sharing manager of the source mobile device is activated. The user can activate it to share received or played media, or the media sharing manager is configured to be activated when specific types of events occur, such as incoming calls or the download of a song. Then, at a next block 509, low power broadcast of the media stream or media content currently being played in the source mobile device is initiated. Such broadcasts can be over a local FM radio frequency channels, over Bluetooth connections, over IrDA links, over WLAN connections, etc.

Then, at a next block 511, the broadcast is continued until it is terminated by the user of the source mobile device. In one embodiment, the user can also temporarily suspend the broadcasts, such as when an incoming voice call is received. Then, at a next block 513, the broadcast transmission of the media stream ends at end of media stream. Finally, the media sharing is terminated at the end block 515.

In one embodiment, the broadcasts are continued regardless of the presence of at least one listener, i.e. a recipient mobile device. In a different embodiment, the source mobile device is able to determine if at least one recipient mobile device is currently connected and able to listen to the shared media stream and the source mobile device does not broadcast if it determines that no recipient mobile device is currently able to receive the broadcasts (i.e. not connected or in the range on the low powered local broadcasts).

In one embodiment, a source client device and a listening client device share media locally when the source client device receives a media stream, such as a download of an MP3 song, or an incoming voice phone call. The sharing is setup by selecting an FM station on the listening client devices and the same FM station on the source client device. Wireless FM means is employed to transmit the audio stream from source client device to other listening client devices. The same FM station must be selected by the source client device and the listening client devices. The audio stream, such as audio from an incoming voice call, is transmitted wirelessly to the listening client devices using FM radio frequencies.

In one related embodiment, an FM transmitter attaches to the source client device, such as a mobile phone, through a special connector, such as Fast port. Menus in the mobile phone allows a user to control the transmitting frequency, and the FM transmissions have a range of up to 10 meters. Since the FM transmitter, such as MMR-60 unit, remembers the last used frequency, it's easy to reconnect to the transmitting channel/frequency from a listening client device. When an incoming phone call comes in, for example, or when the music is played on the source client device, the audio stream is transmitted via the FM transmitter to the listening client device where it is rendered/played.

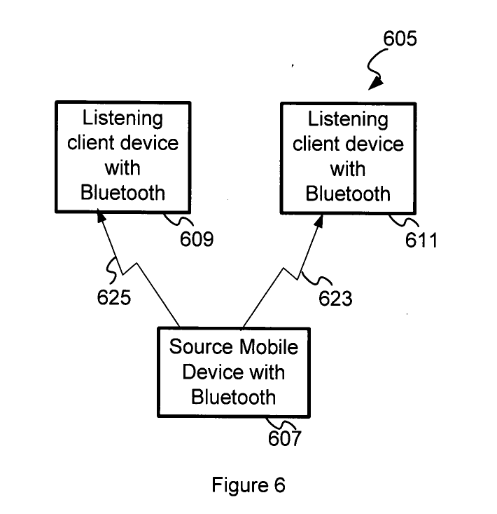

FIG. 6 is a perspective block diagram of a local media sharing network wherein more than one listening client devices 609, 611 can share media streams being locally shared by a source mobile device with Bluetooth connectivity 607. The source mobile device with Bluetooth 607 is capable of broadcasting media streams to more than one listening client devices 609, 611 over Bluetooth connections. Thus incoming voice calls, downloaded streaming audio songs, etc. are shared with one or more listening client devices 609, 611 by a source mobile device 607.

In one embodiment, a Bluetooth based broadcast of media streams is facilitated for sharing the media streams. Bluetooth radios connect to each other in piconets, which are formed by a master radio simultaneously connecting up to seven slave radios. As such, in a related embodiment, up to seven client listening devices are able to receive shared media streams transmitted by a source client device, such as a mobile phone.

Select an FM station on the listening client devices and the same FM station on the source client device, and via Wireless FM means transmit the audio stream from source device to other listening client devices. The same FM station must be selected by the source client device and the listening client devices. The audio stream, such as audio from an incoming voice call, is transmitted wirelessly to using FM radio frequencies.

In one embodiment, an FM receiver built into the source mobile phone is used to receive FM transmissions, such as music from an FM station. Using menus in the mobile phone the user selects an FM station to receive music and FM programming such as news. Since In addition, using additional menus, such FM reception is locally shared with other listening client devices with Bluetooth 611, 609. It is easy to reconnect to the transmitting channel/frequency from a listening client device. When a incoming phone call comes in, for example, or when the music is played on the source mobile device 607 over FM radio, the corresponding audio stream is shared via Bluetooth to the listening client devices 609, 611 where it is rendered/played.

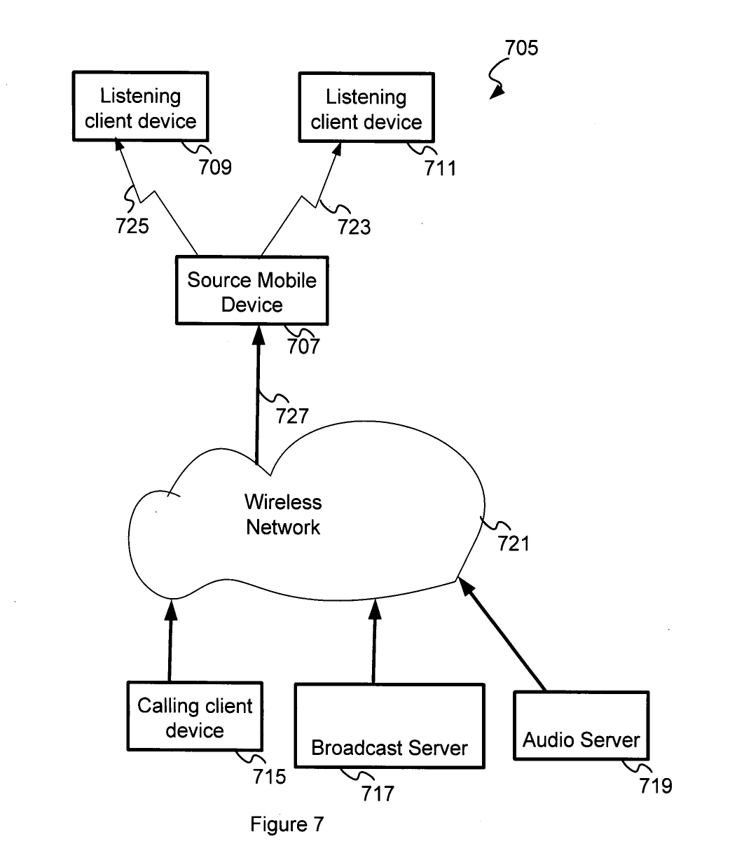

FIG. 7 is a perspective block diagram of a local sharing environment 705 wherein a wireless network 721 provides various kinds of online broadcast data as well as voice calls and wherein a source mobile device 707 receives them and shares them locally with one or more listening client devices 709, 711. The local sharing conducted by the mobile device 707 with the one or more listening client devices 709, 711 does not involve the wireless network 721. Only the source mobile device 707 is directly connected to or associated with the wireless network 721. The listening clients 709, 711 may not even be on the same wireless network 721—instead they may be subscribers of a different wireless (or wired) network altogether. The source mobile device 707 employs 3G, GPRS, GSM, VoIP, CDMA, WCDMA, UMTS or other standard wireless protocols to interact with the wireless network 721, and with a broadcast server 717, an audio server 719 or a call client device 715 via the wireless network 721. It uses other low power local sharing protocols to locally share content, such as received calls or streaming media, with the listening client devices 709, 711. For example, it employs Bluetooth or 802.11 based protocols for local sharing. A set of menus are provided by the source mobile device 707 to let the user initiate local sharing, provide information that can help in the configuration of local sharing and for the termination of local sharing of received calls and broadcast/multicast media. Broadcast media received are retransmitted to the local client devices 709, 711, over different communication means than the one they are received on. Multicast media may selectively be forwarded to local client devices 709, 711 using appropriate protocol translations or bridging.

In one embodiment, a received call can be shared with the listening client devices without being locally played or locally output. Thus a user of the source mobile device 707 that receives the incoming call does not listen to it or participate in it, instead, one or more listening client devices 709, 711 receive the incoming call. In a related embodiment, the local client devices 709, 711 can not only receive calls locally shared by the source mobile device 707, but also participate in the calls, with the source mobile device 707 being capable of such supporting such two-way communication locally.

In one embodiment, the broadcast server 717 is a TV broadcast server such as a DVB-H, MediaFlo or other similar broadcast servers. The local client devices 709, 711 receive TV programs locally from the source mobile device 707 that are received by the source mobile device 707 from the broadcaster server 717. The source mobile device 707 may receive TV broadcasts over a 3G wireless network 721 or over DVB-H and other broadcast networks that are associated with the 3G wireless network 721.

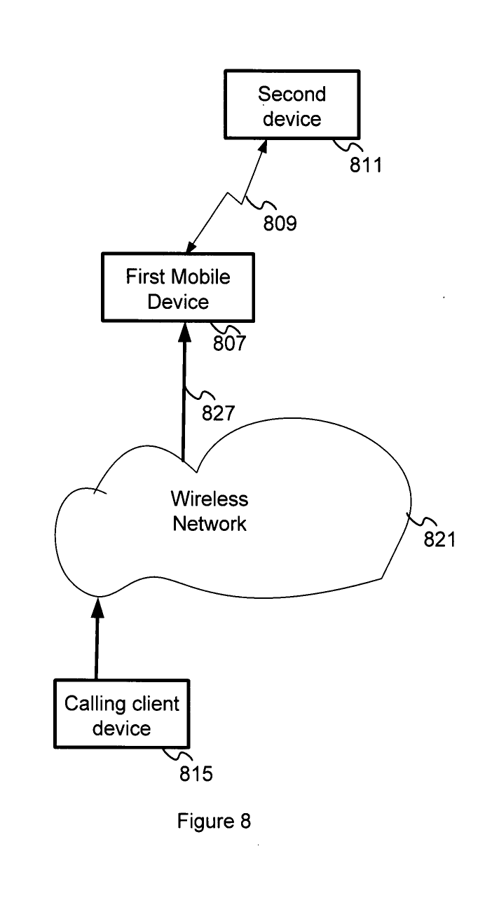

FIG. 8 is a perspective block diagram of an infrastructure where a first mobile device associated and communicatively coupled to a wireless network 821 is capable of conducting a local call transfer, without involving a wireless network 821, to a second mobile device 811. The incoming call that is locally transferred to the second mobile device 811 is billed to the first mobile device 807 by the wireless network 821, as the wireless network 821 is essentially ignorant of any local sharing being conducted by the first mobile device 807. The calling client device 815 may be a wireless device such as a 3G device, or a landline phone, etc.

The first mobile device 807 is capable of conducting a local call transfer, wherein another local phone in its premises, mobile or otherwise, is configured to receive a transferred call. The first mobile device 807 is configured to communicate with other local devices such as second device 811, that are capable of handling calls transferred to them by the first mobile device 807. The first mobile device 807 as well as the second device 811 to which the call is locally transferred can listen and participate on the incoming phone call that is locally transferred.

The present invention also provides for local call forwarding by the first mobile device 807 wherein an incoming call from a calling client device 815 is not taken by the user of the first mobile device 807 (because the user is busy or otherwise engaged) but forwarded locally to the second device 811 where another user takes the incoming call instead of the user of the first mobile device 807 taking the call.

The present invention supports local call forwarding that makes it possible for a first user using a mobile device to let another user on another mobile device in communicative local proximity to take the call on his behalf, wherein the first user's mobile device facilitates the receipt and local transfer of the incoming call to the another mobile device. For example if a user cannot take a call on his phone but wants the person next to him to take it on his phone, without rerouting it through the wireless network 821, rather sending incoming audio (2 way) stream to phone of the person next to him, the local forwarding feature facilitates that.

In one embodiment, for call forwarding, the first mobile device 807 is configured by the user to accept an incoming call, open a local sharing session with the second device 811, and then forward the incoming call to the second device 811 with the first mobile device 807 being silent and non-participatory on the call, but providing two-way communication with the second device 811 for the duration of the call and also noting a termination control provided to the second device 811. In one related embodiment, the second mobile device is capable of only receiving a locally forwarded call or a locally transferred call. It is not capable of terminating it or managing the incoming call. The first mobile device 807 that forwards the call is only capable of initiating or configuring call forwarding and of terminating the call subsequently. In another embodiment, the second mobile device is capable of not only receiving a locally forwarded call or a locally transferred call but also of prematurely terminating it if necessary, based on user input.

The first mobile device 807 comprises a sharing client that supports local sharing of different kinds, including local call forwarding and local call transfer. It also provides user interface screen to initiate such activities, terminate such activities, configure such activities, etc. In a related embodiment, it also supports receiving locally call forwarded calls, and locally call transferred calls, etc. from another (similar) local sharing device.

In one embodiment, the first mobile device 807 becomes a proxy for a mobile service (subscribed to by a user of the first mobile device 807) that is forwarded to the second mobile device by means of locally sharing the mobile service. The first mobile device does not consume the mobile service—rather it serves as a proxy such that the service is consumed on the second mobile device. However, for any billing purposes, the first mobile device serves as a target/consumer. The first mobile device can control its behavior as a proxy, initiate such sharing and terminate such sharing. In the middle of using the mobile service, it can terminate local sharing and start displaying/consuming the mobile service itself. In one related embodiment, the second device is a laptop or a PC.

In one embodiment the second device 811 is similar in capability to the first mobile device and can not only transfer and forward calls for local sharing but also receive them when in the communicative proximity with the first mobile device 807.

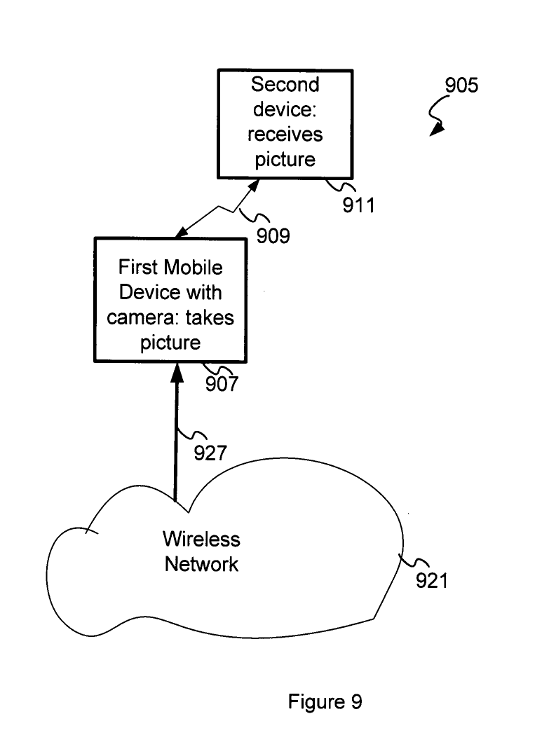

FIG. 9 is a perspective block diagram of a first mobile device 907 that can share its pictures taken on an onboard/built-in camera with other devices 911 using a locally sharing means. Both the first mobile device 907 and the second device 911 (which may or may not be a mobile device) are capable of communicating over a locally sharing communication means 909, which is different than a wireless communication means 927, such as 3G, GSM, CDMA, GPRS, etc. employed for communication between the first mobile device 907 and a wireless network 921 with which it is associated.

Using a local sharing client, such as a camera client capable of communicating locally, the first mobile device 907 shares incoming calls, streaming media, pictures, etc. locally (without employing the cellular wireless network 921) with a second device 911. The second device 911 may also have a similar client and be able to share locally with the first mobile device 907.

The first mobile device 907 facilitates mobile picture sharing—sharing of a picture taken by a user using the first mobile device 907 with other devices in the vicinity, such as the second device 911. Such local mobile picture sharing is conducted without a computer or a server used in the process. In one embodiment, the first mobile device 907 comprises a local sharing client that shares pictures taken by a camera on the first mobile device 907. The first mobile device 907 may also comprise a camera client that manages the camera, and the local sharing client may interact with it as necessary, thereby providing instant access to pictures taken by the first mobile device 907 to (a user of) the second device 911. The first mobile device 907 and the second device 911 are not required to share the same wireless network 921. In particular, only the first mobile device 907 may be on a wireless network 921 and the second device 911 may not be on any wireless network at all, and still be able to locally share with the first mobile device 907. Although the camera client and the local sharing client are two different components that interact with each other, in one embodiment, these two components are merged into a single camera component (that is capable of locally sharing).

In one embodiment, the first mobile device 907 takes pictures (user initiated or device initiated) and stores them in an album locally. Then it notifies the second device 911, that the new pictures are available. It also shares the album with the new pictures. The second device 911 has the option to browse through the album stored in the first mobile device, a picture sharing client in first mobile device 907 and a corresponding one in second device 911 facilitating such sharing/browsing. The second device 911 also has the option to download the shared pictures from the first mobile device 907 for viewing locally.

The first mobile device 907 can take pictures and share them with the second device 911 thereby making it possible for the user of the second device to view it in real-time. In addition, using the same camera, the first mobile device 907 can take movies (in MPEG format for example) and share them with the second device 911 thereby making it possible for the user of the second device to view the movie in real-time. The second device 911, in a related embodiment, is capable of scaling the movie (or the picture) being shared to an appropriate size, and employing the appropriate number of pixels, adjusting the contrast, brightness, and other parameters, including frames per second, as necessary.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

The terms “audio preamble” and “voice preamble” as used herein may refer to recorded voice inputs that a user records, to provide a question/prompt in human language, that also selectively incorporates responses in multiple choice format to aid selection by a recipient. The audio preamble may be captured by a mobile device in MP3 format, AMR format, WMA format, etc.

The term “audio-assisted questionnaire” as used herein may refer to a questionnaire comprising audio portions, such as audio preambles, audio supplementary information, audio descriptions of multiple choices, etc. that make it possible for a recipient to listen to most of the information of the questions in a questionnaire (employing human voices, in audible form) without having to read all of that in a small screen of a mobile device, without requiring scrolling through textual descriptions on a limited/constrained device.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A mobile device that receives a mobile service in a wireless network, the mobile device comprising:
at least one non-volatile memory having stored therein one or both of firmware and software;
a bearer communication circuitry;
a local communication circuitry;
at least one processor operably coupled to the bearer communication circuitry, the local communication circuitry and the at least one non-volatile memory, wherein the at least one processor, during operation, at least:
receives the mobile service employing the bearer communication circuitry;
shares at least one portion of the mobile service locally employing the local communication circuitry with a second mobile device in its proximity; and
manages the sharing of the at least one portion of the mobile service with the second mobile device until the mobile service is terminated or the second mobile device indicates termination of sharing.

2. The mobile device of claim 1 further comprising:
a local communication protocol software that employs the local communication circuitry for communication with the second mobile device;
the at least one processor, during operation, in addition at least:
receives information indicating that the second mobile device is a target device for sharing;
establishes local communication with the second mobile device over the local communication protocol, if necessary;
determines that the mobile device is communicatively coupled with the second mobile device over the local communication protocol; and
selectively initiates sharing of the mobile service with the second mobile device.

3. The mobile device of claim 2 wherein the mobile service is a phone service.

4. The mobile device of claim 2 wherein the mobile service is a streaming audio service.

5. The mobile device of claim 2 wherein the mobile service is a video service.

6. The mobile device of claim 2 wherein the mobile service is one of a multi-media broadcast service or a multicast service.

7. The mobile device of claim 2 wherein the mobile service is a multicast service.

8. The mobile device of claim 2 further comprising:
a camera capable of capturing a digital picture;
the mobile device sharing the digital picture captured by the camera with the second mobile device.

9. The mobile device of claim 2 further comprising:
the camera capable of recording a digital video; and
the mobile device sharing the digital video recorded by the camera with the second mobile device.

10. The mobile device of claim 2 further comprising:
a media sharing manager; and
the media sharing manager, when triggered, shares a content being displayed or a media stream being received by the mobile device with the second mobile device.

11. The mobile device of claim 2, further comprising:
a phone call sharing manager;
a phone call handling client;
wherein the mobile service is a phone call service;
wherein the phone call handling client handles an incoming phone call and enables a user to receive the incoming phone call on the mobile device; and
wherein the phone call sharing manager selectively initiates the sharing of the incoming phone call with the second mobile device when the mobile device receives a user-generated trigger initiating the sharing of the incoming phone call.

12. The mobile device of claim 11, further comprising:
the phone call sharing manager terminating the sharing of the incoming phone call when the mobile device receives a user-generated termination trigger for termination of the sharing of the incoming phone call or when the user terminates the incoming phone call.

13. A method performed by a mobile device that receives a mobile service over a wireless network, the method comprising:
receiving, over the wireless network, the mobile service employing a bearer communication circuitry;
sharing at least one portion of the mobile service locally, employing a local communication circuitry, with a second mobile device in its proximity; and
managing the sharing of the at least one portion of the mobile service with the second mobile device until the mobile service is terminated or the second mobile device indicates termination of sharing.

14. The method performed by a mobile device 13 further comprising:
processing target information indicating that the second mobile device is a target device for sharing;
establishing a local communication with the second mobile device over a local communication protocol, if necessary, wherein a local communication protocol software employs a local communication circuitry in the mobile device for communication with the second mobile device;
determining that the mobile device is communicatively coupled with the second mobile device over the local communication protocol; and
initiating the sharing of the mobile service with the second mobile device.

15. The method of claim 14 wherein the target information is either provided by a user of the mobile device or accessed from a configuration data.

16. The method of claim 15 wherein the mobile service is one of set of services comprising a phone service, a digital photo capturing service, a video capturing service, a broadcast service, a multimedia service, an audio streaming service and a video streaming service.

17. The method of claim 16 wherein the wireless network is one from a set of networks comprising a cellular network, a WiMAX network, a WLAN network and Internet.

18. The method of claim 16 wherein the local communication protocol is one of set of protocols comprising a Bluetooth protocol, WiMAX, an ultra-wideband protocol and an infrared data association (IrDA) protocol.

19. A mobile device with a bearer communication circuitry for accessing a wireless bearer network, the mobile device comprising:
a local communication circuitry for interactions with a second mobile devices in its proximity employing a local communication protocol;
at least one non-volatile memory having stored therein one or both of firmware and software;
at least one processor operably coupled to the bearer communication circuitry, the local communication circuitry and the at least one non-volatile memory;
a mobile service client resident in the at least non-volatile memory in the mobile device that receives a mobile service and presents it on the mobile device;
a sharing client resident in the at least one non-volatile memory that, when triggered, locally shares at least a portion of the mobile service received over the wireless bearer network with the second mobile device employing the local communication protocol.

20. The mobile device of claim 19 further comprising:
the sharing client initiating an interaction with the second mobile device; and
the sharing client managing the sharing of the mobile service with the second mobile device;
the sharing client terminating the sharing of the mobile service when it determines that the mobile service has ended or when it determines that the second mobile device has terminated sharing.

21. The mobile device of claim 20 wherein the mobile service client is a phone call handling software and the mobile service is a phone call service.

22. A method for sharing a service and data between a first mobile device communicatively coupled to a wireless network and a second mobile device, the system comprising:
receiving, by the first mobile device, the service and data over the wireless network;
establishing connectivity, by the first mobile device with the second mobile device, for local sharing of the service and data;
sharing the service and data over the established connectivity by the first mobile device with the second mobile device; and
terminating the sharing of the service and data by the first mobile device.

23. The method for sharing a service and data according to claim 22, further comprising:
stopping the sharing of the service and data by the second mobile device.

24. The method for sharing a service and data according to claim 23 wherein the service is a phone service and the first mobile device locally shares an incoming phone call with the second mobile device over the established connectivity.

25. The method for sharing a service and data according to claim 24 wherein the first mobile device forwards an incoming call to the second mobile device for sharing locally with the first mobile device being silent and non-participatory on the incoming call while providing two-way communication with the second mobile device for the duration of the incoming call.

26. The method for sharing a service and data according to claim 24 wherein the first mobile device serves as a proxy for consuming the mobile service locally by local sharing on the second mobile device.
